(19) United States
(12) Patent Application Publication
(10) Pub. No.: US 2025/0316679 A1
(43) Pub. Date: Oct. 9, 2025

(54) NEGATIVE ELECTRODE PLATE FOR A LITHIUM BATTERY AND A LITHIUM-ION SECONDARY BATTERY COMPRISING SAME

(71) Applicant: MURATA MANUFACTURING CO., LTD., Kyoto (JP)

(72) Inventors: Yan ZHOU, Shanghai (CN); Li WANG, Shanghai (CN); Yuli LI, Shanghai (CN); Meng YU, Shanghai (CN); Kazumasa TAKESHI, Shanghai (CN)

(21) Appl. No.: 19/070,926

(22) Filed: Mar. 5, 2025

(30) Foreign Application Priority Data
Apr. 9, 2024 (CN) 2024104241852

(51) Int. Cl. H01M 4/133; H01M 4/02; H01M 4/36; H01M 4/48; H01M 4/587; H01M 4/62; H01M 10/0525

(52) U.S. Cl. CPC H01M 4/133; H01M 4/364; H01M 4/483; H01M 4/587; H01M 4/62; H01M 4/622; H01M 10/0525; H01M 2004/027

(57) ABSTRACT

The present disclosure provides a negative electrode plate for a lithium battery and a lithium-ion secondary battery comprising same. The negative electrode plate includes a negative electrode current collector and a negative electrode material, wherein the negative electrode material includes: a negative electrode active material including a silicon-based material or a mixture of graphite and silicon-based material; a conductive agent; and a polyacrylic acid-based binder having a pH of 4.5 to 8.5 and a viscosity of 3500 Pa·s to 30000 Pa·s.

### CROSS REFERENCE TO RELATED APPLICATIONS

The present application claims priority to Chinese patent application no. 2024104241852, filed on Apr. 9, 2024, the entire contents of which are incorporated herein by reference.

### BACKGROUND

The present disclosure relates to lithium ion battery technology.

In recent years, with the continuous updating of electronic technology, the demand for battery devices used to support energy supply for electronic devices has also been increasing. Nowadays, there is a need for batteries that can store more electricity and output high power. Traditional lead-acid batteries and Nickel-metal hydride batteries, for example, can no longer meet the requirements of new electronic products. Therefore, lithium batteries have attracted widespread attention. During the development of lithium battery, its capacity and performance have been effectively improved. Lithium ion batteries are widely used in fields, such as, for example, 3 C digital products, electric tools, electric vehicles, aerospace, due to advantages of lithium ion batteries including, for example, high operating voltage, high energy density, long lifetime, wide operating temperature range, and environmental friendliness.

Negative electrode materials having high initial efficiency are crucial in improving the energy density of lithium batteries. Negative electrode materials having high initial efficiency currently available in the market include prelithiated silicon oxide materials, premagnesiated silicon oxide materials, and silicon-carbon materials. Among them, prelithiated silicon monoxide has certain advantages in improving the initial efficiency and cycle stability, etc., of lithium batteries, and thus it has attracted the attention of material manufacturers and battery manufacturers. However, during its use, there are problems such as gelation of paste, gas generation of paste and high selectivity to binder, etc. Specifically, the prelithiated silicon monoxide is alkaline and can react with the acidic binder in the negative electrode material of lithium battery, causing the negative electrode paste to gelate and difficult to be coated. Moreover, the acidic binder can damage the carbon layer on the surface of the prelithiated silicon monoxide material, resulting in gas generation, which reduces the capacity and efficiency of lithium battery.

In view of the above existing problems, for example, it is necessary to develop a negative electrode plate for a lithium battery and a lithium-ion secondary battery including same that can improve the capacity and efficiency of lithium ion battery, and solve the problems of gelation of paste, gas generation of paste caused by the prelithiated silicon oxide materials, as well as reduce its selectivity to binder.

### SUMMARY

The present disclosure relates to lithium ion battery technology. More specifically, the present disclosure relates to a negative electrode plate for a lithium battery and a lithium ion secondary battery including same.

The present disclosure, in an embodiment, relates to providing a negative electrode plate for a lithium battery and a lithium-ion secondary battery including same, in order to solve the problems, for example, of gelation of paste, gas generation of paste and high selectivity to binder as well as low capacity and efficiency existing in the negative electrode materials for a lithium battery, especially prelithiated silicon oxide materials.

In an embodiment, the present disclosure provides a negative electrode plate for a lithium battery comprising a negative electrode current collector and a negative electrode material, the negative electrode material comprises: a negative electrode active material including a silicon-based material or a mixture of graphite and silicon-based material; a conductive agent; a polyacrylic acid-based binder having a pH of 4.5 to 8.5 and a viscosity of 3500 Pa·s to 30000 Pa·s. In an embodiment, the pH of the polyacrylic acid-based binder is 4.5 to 7.0, wherein the negative electrode material further comprises an alkaline additive. In an embodiment, the pH of the polyacrylic acid-based binder is greater than 7.0 and less than or equal to 8.5, wherein the negative electrode material optionally comprises an alkaline additive.

Further, the silicon-based material, in an embodiment, comprises prelithiated silicon monoxide, preferably, the pH of the silicon-based material is less than 12 in an embodiment.

Further, the graphite, in an embodiment, comprises natural graphite, artificial graphite, or a mixture thereof.

Further, the binder, in an embodiment, has a pH of 6 to 8 and a viscosity of 3800 Pa·s to 20000 Pa·s.

Further, the alkaline additive, in an embodiment, is sodium lignosulphonate.

In an embodiment, the negative electrode material comprises the alkaline additive, wherein the amount of the alkaline additive in the negative electrode material is 0.2 wt % to 4 wt % based on the solid weight of the negative electrode material.

In an embodiment, the binder comprises a modified functional group that is hydrolysable under neutral or alkaline conditions, wherein the content of the modified functional group in the binder is less than 30 wt %.

In an embodiment, the negative electrode active material comprises a mixture of graphite and silicon-based material, wherein, based on the solid weight of the negative electrode material, the negative electrode material comprises 93 wt % to 97 wt % of the negative electrode active material, 1 wt % to 3 wt % of the conductive agent, and 2 wt % to 4 wt % of the binder. In an embodiment, the negative electrode active material comprises a silicon-based material, wherein, based on the solid weight of the negative electrode material, the negative electrode material comprises 80 wt % to 90 wt % of the negative electrode active material, 5 wt % to 10 wt % of the conductive agent, and 5 wt % to 10 wt % of the binder.

Yet another aspect of the present disclosure provides a lithium-ion secondary battery comprising a positive electrode plate, a negative electrode plate, a separator, and an electrolyte, wherein the negative electrode plate is the negative electrode plate as described in the above aspects.

By applying the technical solutions of the present disclosure, in an embodiment, the capacity and efficiency of lithium batteries can be improved by using a polyacrylic acid-based binder having specific pH and viscosity in the negative electrode materials for lithium batteries and adding an alkaline additive to the binder at a specific pH level; solving the problems of, for example, gelation of paste, gas generation of paste in paste preparation process of prelithiated silicon oxide materials as well as reducing its selectivity to binder and extending the storage time of paste; and expanding the selection range of the polyacrylic acid-based binders in the negative electrode materials for lithium batteries, so that the weakly acidic polyacrylic acid-based binders can also be applied to the negative electrode materials for lithium batteries.

### BRIEF DESCRIPTION OF THE FIGURES

The accompanying drawings of the description, which form a part of the application, are used to provide a further understanding of the present disclosure. The illustrative embodiments and their descriptions of the present disclosure are used to explain the present disclosure, and do not constitute an improper limitation thereto. In the accompanying drawings:

FIG. 1 is an image of the negative electrode paste prepared in Example 1.

FIG. 2 is an image of the negative electrode paste prepared in Example 2.

FIG. 3 is an image of the negative electrode paste prepared in Example 3.

FIG. 4 is an image of the negative electrode paste prepared in Example 4.

FIG. 5 is an image of the negative electrode paste prepared in Example 5.

FIG. 6 is an image of the negative electrode paste prepared in Example 6.

FIG. 7 is an image of the negative electrode paste prepared in Comparative example 1.

FIG. 8 is an image of the negative electrode paste prepared in Comparative example 2.

FIG. 9 is an image of the negative electrode paste prepared in Comparative example 3.

FIG. 10 is an image of the negative electrode paste prepared in Comparative example 4.

FIG. 11 is an image of the negative electrode paste prepared in Example 7.

FIG. 12 is an image of the negative electrode paste prepared in Example 8.

### DETAILED DESCRIPTION

The present disclosure will be described in further detail below including with reference to examples according to an embodiment. It should be noted that the examples and features in the examples in the present application can be combined with each other according to an embodiment.

As described in the background, the negative electrode materials for lithium batteries, especially prelithiated silicon oxide materials, have problems of gelation of paste, gas generation of paste and high selectivity to binder as well as low capacity and efficiency. In order to solve the above technical problems, in an embodiment, the present application provides a negative electrode plate for a lithium battery, wherein the negative electrode plate comprises a negative electrode current collector and a negative electrode material, the negative electrode material comprises: a negative electrode active material, the negative electrode active material comprises a silicon-based material or a mixture of graphite and silicon-based material; a conductive agent; a polyacrylic acid-based binder having a pH of 4.5 to 8.5 and a viscosity of 3500 Pa·s to 30000 Pa·s. In an embodiment, the pH of the binder is 4.5 to 7.0, wherein the negative electrode material further comprises an alkaline additive. In an embodiment, the pH of the binder is greater than 7.0 and less than or equal to 8.5, wherein the negative electrode material optionally comprises an alkaline additive.

In the present disclosure, in an embodiment, the capacity and efficiency of lithium batteries can be improved by using a polyacrylic acid-based binder having specific pH and viscosity in the negative electrode materials for lithium batteries and adding an alkaline additive to the binder at a specific pH level thereby, for example, solving the problems of gelation of paste, gas generation of paste in the paste preparation process of prelithiated silicon oxide materials as well as reducing its selectivity to binder and extending the storage time of paste; and expanding the selection range of the polyacrylic acid-based binders in the negative electrode materials for lithium batteries, so that the weakly acidic polyacrylic acid-based binders can also be applied to the negative electrode materials for lithium batteries.

The inventors have found that in the negative electrode materials for lithium batteries, especially in the negative electrode materials using prelithiated silicon monoxide as the negative electrode active material, if the pH of the binder is too low or too high, it will lead to the aggravation of gelation and gas generation of the negative electrode paste, and will adversely affect the charge and discharge capacity and efficiency. If the pH of the binder is too low, it will cause damage to the carbon coating layer of the prelithiated silicon monoxide, increasing the exposure of internal Si in alkaline environments, and increasing gas generation. If the pH of the binder is too high, it will increase the pH of the negative electrode material system, promoting the gas generation of the battery, and there is the possibility of cross-linking with the negative electrode active material, which will aggravate the gelation.

In a preferred embodiment, the silicon-based material comprises prelithiated silicon monoxide.

In a preferred embodiment, the pH of the prelithiated silicon monoxide is less than 12, preferably less than 11.5.

The use of the prelithiated silicon monoxide at a specific pH range is beneficial for further improving the problem of gas generation of paste during the paste preparation process of prelithiated silicon oxide materials. Gas generation problem is easier to occur when the pH of the prelithiated silicon monoxide is higher than 12.

As mentioned above, although the prelithiated silicon monoxide material has high capacity and efficiency as the negative electrode material for lithium battery, it is more prone to problems of gelation and gas generation. In addition, if the pH of the prelithiated silicon oxide is too high, it will accelerate the gas generation and gelation of Si therein in alkaline conditions, and at the same time, it will lead to, for example, the hydrolysis of the binder, thus destroying the structure of the binder, reducing the adhesive performance of the binder and promoting gas generation.

In a preferred embodiment, the graphite comprises natural graphite, artificial graphite, or a mixture thereof.

In a preferred embodiment the binder has a pH of 6 to 8 and a viscosity of 3800 Pa·s to 20000 Pa·s. Using binders with preferred pH and viscosity ranges is more advantageous for obtaining the negative electrode materials with good performance.

In a preferred embodiment, the alkaline additive includes sodium lignosulfonate.

When sodium lignosulfonate is used as an alkaline additive, it will have good solubility in water, resulting in good dispersibility in the paste, which is beneficial for further improving the performance of the negative electrode materials.

In a preferred embodiment, the negative electrode material comprises an alkaline additive, wherein the amount of the alkaline additive in the negative electrode material is 0.2 wt % to 4 wt % based on the solid weight of the negative electrode material.

The use of an alkaline additive within the above content range is beneficial for further improving the performance of the negative electrode materials, wherein when the content of the alkaline additive is too high, it may deteriorate the stability of the paste.

In a preferred embodiment, the binder comprises a modified functional group that is hydrolysable under neutral or alkaline conditions, wherein the content of the modified functional group in the binder is less than 30 wt %. In an embodiment, the pH of the binder is greater than 7.0 and less than or equal to 8.5, and the binder comprises a modified functional group that is hydrolysable under neutral or alkaline conditions, wherein the content of the functional group that is hydrolysable under neutral or alkaline conditions (such as —C≡N, —C═NH₂, and other such suitable functional groups) in the binder in the binder is less than 30 wt %.

The use of the binder of a specific content with modified functional groups that is hydrolysable under neutral or alkaline conditions is beneficial for further improving the problems of gas generation of paste and gelation of paste, and can improve other performance of the battery, such as flexibility or peel strength of the electrode plate. In particular, when the content of the modified functional group is more than 30 wt %, the problems of gelation and gas generation of paste may be aggravated. The pH of the binder can be determined by the following method: taking out the battery electrode plate, removing the electrode plate on the current collector and immersing it in water to dissolve the binder in water, filtering and measuring the pH of the solution. The content of the modified functional group in the binder can be determined by quantitative analysis of the components of binder using nuclear magnetic resonance and organic element analyzer.

In a preferred embodiment, the negative electrode active material comprises a mixture of graphite and silicon-based material, based on the solid weight of the negative electrode material, the negative electrode material comprises 93 wt % to 97 wt % of the negative electrode active material, 1 wt % to 3 wt % of the conductive agent, and 2 wt % to 4 wt % of the binder; and the negative electrode active material comprises a silicon-based material, based on the solid weight of the negative electrode material, the negative electrode material comprises 80 wt % to 90 wt % of the negative electrode active material, 5 wt % to 10 wt % of the conductive agent, and 5 wt % to 10 wt % of the binder.

Another aspect of the present application provides a lithium-ion secondary battery comprising a positive electrode plate, a negative electrode plate, a separator, and an electrolyte, wherein the negative electrode plate is the negative electrode plate as described above.

The present application will be described in further detail below in combination with specific examples according to an embodiment.

The lithium-ion secondary batteries of the examples were prepared by the following steps.

Preparation of negative electrode plate: a negative electrode active material, a conductive agent, a binder, an optional additive, and a solvent were stirred to prepare a negative electrode paste. Then, the negative electrode paste was applied onto the negative electrode current collector, which was dried and press molded to form a negative electrode plate.

Preparation of electrolyte: an organic solvent, a lithium salt, and an additive were mixed to prepare the electrolyte.

Battery assembly: the prepared negative electrode plate, a separator, a lithium plate, and a battery shell were stacked in sequence and injected with the electrolyte, which were then sealed to assemble into a half battery.

The lithium-ion secondary batteries of the examples were specifically prepared as follows.

### Example 1

8.5 g of a prelithiated silicon oxide material with a pH of 11.3, 0.5 g of a polyacrylic acid-based binder with a pH of 4.7, 1 g of conductive carbon black, and 0.17 g of sodium lignosulfonate were uniformly mixed to form a paste, which was then applied onto a copper foil current collector. It was oven-dried and die cut to make a negative electrode plate, the prepared negative electrode plate was placed in a vacuum drying oven for 5 hours, and then taken out for battery assembly. The negative electrode plate, separator, spacer, and battery shell were stacked in sequence and injected with 100 ml of electrolyte, which were then sealed and assembled into a half battery.

### Example 2

The difference from Example 1 lied in that the amount of the alkaline additive added (0.017 g) was different. See Table 1.

### Example 3

The difference from Example 1 lied in that the pH of the prelithiated silicon monoxide, the pH, viscosity and content of the hydrolysable functional group of the binder, and the amount of the alkaline additive added were different. See Table 1.

### Example 4

The difference from Example 1 lied in that the pH of the prelithiated silicon monoxide, the pH, viscosity and content of the hydrolysable functional group of the binder, and the amount of the alkaline additive added were different. See Table 1.

### Example 5

The difference from Example 1 lied in that the pH of the prelithiated silicon monoxide, the pH, viscosity and content of the hydrolysable functional group of the binder, and the amount of the alkaline additive added were different. See Table 1.

### Example 6

The difference from Example 1 lied in that the pH of the prelithiated silicon monoxide, the pH, viscosity and content of the hydrolysable functional group of the binder, and the amount of the alkaline additive added were different. See Table 1.

### Example 7

The difference from Example 1 lied in that the pH of the prelithiated silicon monoxide was 12.

### Example 8

The difference from Example 4 lied in that the content of the modified functional group was greater than 30.

### Example 9

The difference from Example 4 lied in that the amount of the alkaline additive added was different, and the negative electrode active material was a mixture of prelithiated silicon monoxide and graphite (15/85 (wt %)). See Table 3.

### Example 10

The difference from Example 9 lied in that the pH, viscosity and content of the hydrolyzable functional group of the binder, and the amount of the alkaline additive added were different. See Table 3.

### Comparative Example 1

The difference from Example 1 lied in that the pH of the prelithiated silicon monoxide, the pH, viscosity and content of the hydrolysable functional group of the binder, and the amount of the alkaline additive added were different. See Table 2.

### Comparative Example 2

The difference from Example 1 lied in that the pH and viscosity of the binder, and the amount of the alkaline additive added were different. See Table 2.

### Comparative Example 3

The difference from Example 1 lied in that the amount of the alkaline additive added was different. See Table 2.

### Comparative Example 4

The difference from Example 1 lied in that the pH of the prelithiated silicon monoxide, the pH, viscosity and content of the hydrolysable functional group of the binder, and the amount of the alkaline additive added were different. See Table 2.

The gas generation rate, capacity, and efficiency of the prepared batteries were tested using the following methods. The test results are shown in Tables 1 to 3.

Gas generation test: the prepared paste was placed in aluminum-plastic film, which was sealed and let stand for 15 days. After 15 days, the gas generation rate test was conducted using the water removal method. Gas generation rate (%)=(mass of paste package in water after 15 days of standing—initial mass of fresh paste package in water)/initial mass of fresh paste package in water

Capacity testing: the charge-discharge test was carried out on the battery at a charge-discharge rate of 0.1 C and a charge-discharge voltage in a range of 0V-1.5V so as to obtain the initial capacity and the initial efficiency.

TABLE 1

| | | Binder | | | | Whether the | | | |
|---|---|---|---|---|---|---|---|---|---|
| | pH of | | | Content of | Content of | negative | Gas | | |
| | negative | | | hydrolysable | alkaline | electrode | generation | | |
| | electrode | | Viscosity | functional | additive | paste can | rate | Capacity | Efficiency |
| Examples | material | pH | (mPa · s) | group (wt %) | (wt %) | be coated | (%) | (mAh/g) | (%) |
| 1 | 11.3 | 4.7 | 3800 | 0 | 2% | Yes | 200 | 1320 | 90.4 |
| 2 | 11.3 | 4.7 | 3800 | 0 | 0.2% | Yes | 200 | 1300 | 89 |
| 3 | 11.5 | 7.8 | 15000 | 25 | 0 | Yes | 270 | 1370 | 90 |
| 4 | 11.5 | 8.5 | 20000 | 10 | 0 | Yes | 150 | 1360 | 89.5 |
| 5 | 10.9 | 6.7 | 14000 | 20 | 4% | Yes | 0 | 1390 | 91 |
| 6 | 10.9 | 8 | 16000 | 10 | 1% | Yes | 50 | 1370 | 90.5 |
| 7 | 12 | 4.7 | 3800 | 0 | 2% | Yes | 300 | 1310 | 90 |
| 8 | 11.5 | 8.5 | 20000 | 45 | 0 | Yes | 500 | 1280 | 88 |

TABLE 2

| | | Binder | | | | Whether the | | | |
|---|---|---|---|---|---|---|---|---|---|
| | pH of | | | Content of | Content of | negative | Gas | | |
| | negative | | | hydrolysable | alkaline | electrode | generation | | |
| Comparative | electrode | | Viscosity | functional | additive | paste can | rate | Capacity | Efficiency |
| Examples | material | pH | (mPa · s) | group (wt %) | (wt %) | be coated | (%) | (mAh/g) | (%) |
| 1 | 12 | 8.8 | 30000 | 45 | 0 | Yes | 700 | 1250 | 88 |
| 2 | 11.3 | 4 | 2800 | 0 | 5% | Yes | 400 | 1250 | 85 |
| 3 | 11.3 | 4.7 | 3800 | 0 | 0 | No | / | / | / |
| 4 | 10.9 | 8.5 | 40000 | 10 | 0 | Yes | 700 | 1240 | 86.9 |

TABLE 3

| | | Binder | | | | Whether the | | | |
|---|---|---|---|---|---|---|---|---|---|
| | pH of | | | Content of | Content of | negative | Gas | | |
| | negative | | | hydrolysable | alkaline | electrode | generation | | |
| | electrode | | Viscosity | functional | additive | paste can | rate | Capacity | Efficiency |
| Examples | material | pH | (mPa · s) | group (wt %) | (wt %) | be coated | (%) | (mAh/g) | (%) |
| 9 | 10.9 | 6.7 | 14000 | 20 | 2% | Yes | 0 | 515 | 90.3 |
| 10 | 10.9 | 8.5 | 20000 | 45 | 0 | Yes | 140 | 509 | 86 |

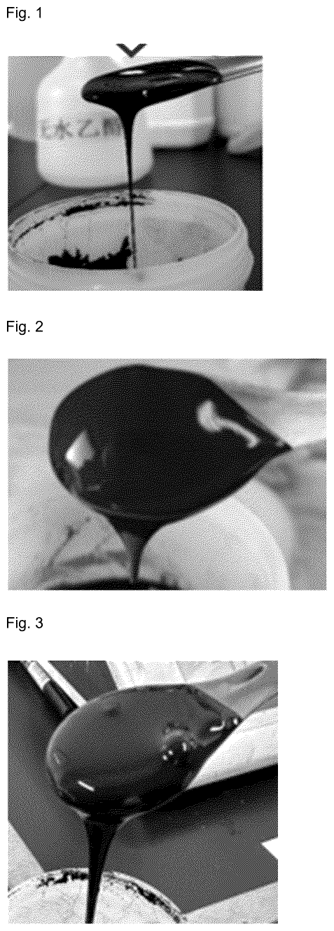

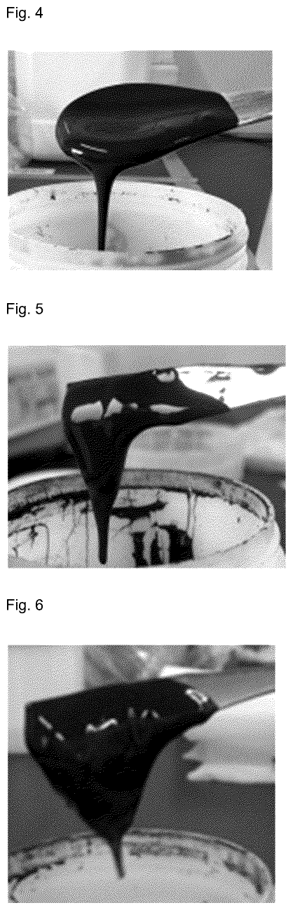

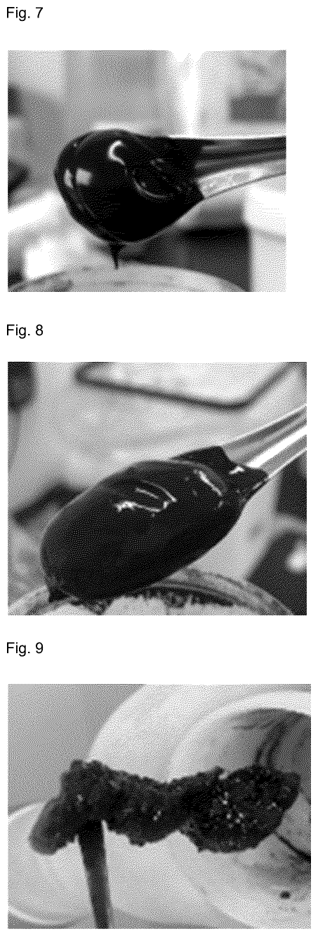

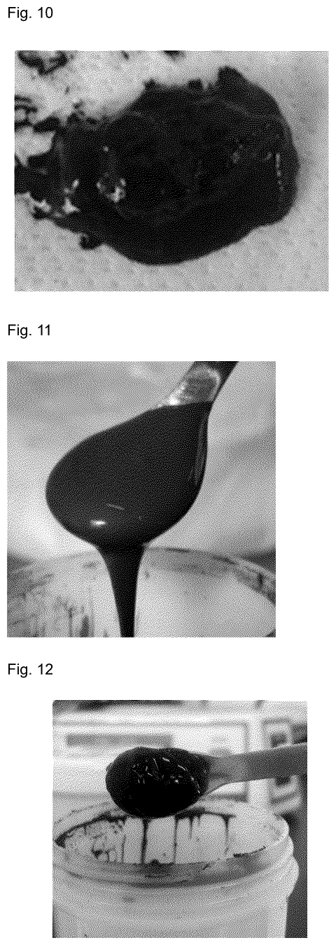

From FIGS. 1-6 (Examples 1-6), FIGS. 7-10 (Comparative Examples 1-4), and FIGS. 11-12 (Examples 7-8), it can be seen that the paste formed in Comparative Example 3 cannot be coated, while coatable pastes were formed in other Examples and Comparative Examples.

By comparing Examples 1-8 with Comparative Examples 1-4, for example, it can be seen that the capacity and efficiency of lithium batteries can be improved and the gas generation can be reduced by using the negative electrode materials of the present disclosure in which a polyacrylic acid-based binder having specific pH and viscosity is used and an alkaline additive is added to the binder having a specific pH.

By comparing Example 1 with Example 7, for example, it can be seen that when the pH of the negative electrode active material is less than 12, it is beneficial to further improve the capacity and efficiency of the lithium batteries and reduce the gas generation.

By comparing Example 4 with Example 8 and Example 9 with Example 10, for example, it can be seen that when the content of hydrolyzable functional group in the binder is less than 30 wt %, it is beneficial to further improve the capacity and efficiency of the lithium batteries and reduce the gas generation.

By comparing Examples 5 and 6 with Examples 1-4, for example, it can be seen that when the binder has a pH of 6 to 8 and a viscosity of 3800 Pa·s to 20000 Pa·s, it is beneficial to further improve the capacity and efficiency of the lithium batteries and reduce the gas generation.

The above descriptions are only the preferred examples of the present disclosure, and are not intended to limit thereto.

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A negative electrode plate for a lithium battery comprising a negative electrode current collector and a negative electrode material, wherein the negative electrode material includes:
a negative electrode active material comprising a silicon-based material or a mixture of a graphite and a silicon-based material; and
a conductive agent;
a polyacrylic acid-based binder having a pH of 4.5 to 8.5 and a viscosity of 3500 Pa·s to 30000 Pa·s.

2. The negative electrode plate according to claim 1, wherein the pH of the polyacrylic acid-based binder is 4.5 to 7.0, and wherein the negative electrode material further includes an alkaline additive.

3. The negative electrode plate according to claim 1, wherein the pH of the polyacrylic acid-based binder is greater than 7.0 and less than or equal to 8.5, and wherein the negative electrode material optionally includes an alkaline additive.

4. The negative electrode plate according to claim 1, wherein the silicon-based material comprises prelithiated silicon monoxide.

5. The negative electrode plate according to claim 1, wherein the graphite comprises natural graphite, artificial graphite, or a mixture thereof.

6. The negative electrode plate according to claim 1, wherein the polyacrylic acid-based binder has a pH of 6 to 8 and a viscosity of 3800 Pa·s to 20000 Pa·s.

7. The negative electrode plate according to claim 1, wherein the negative electrode material includes an alkaline additive, and wherein the alkaline additive is sodium lignosulphonate.

8. The negative electrode plate according to claim 7, wherein an amount of the alkaline additive in the negative electrode material is 0.2 wt % to 4 wt % based on a solid weight of the negative electrode material.

9. The negative electrode plate according to claim 1, wherein the polyacrylic acid-based binder comprises a modified functional group that is hydrolysable under neutral or alkaline conditions, and wherein a content of the modified functional group in the polyacrylic acid-based binder is less than 30 wt %.

10. The negative electrode plate according to claim 1, wherein the negative electrode active material comprises a mixture of the graphite and the silicon-based material, and wherein, based on a solid weight of the negative electrode material, the negative electrode material comprises 93 wt % to 97 wt % of the negative electrode active material, 1 wt % to 3 wt % of the conductive agent, and 2 wt % to 4 wt % of the polyacrylic acid-based binder.

11. The negative electrode plate according to claim 1, wherein the negative electrode active material comprises a silicon-based material, and wherein, based on the solid weight of the negative electrode material, the negative electrode material comprises 80 wt % to 90 wt % of the negative electrode active material, 5 wt % to 10 wt % of the conductive agent, and 5 wt % to 10 wt % of the polyacrylic acid-based binder.

12. The negative electrode plate according to claim 4, wherein the pH of the silicon-based material is less than 12.

13. A lithium-ion secondary battery comprising a positive electrode plate according to claim 1, a negative electrode plate, a separator, and an electrolyte.
